(19) United States
(12) Patent Application Publication
(10) Pub. No.: US 2005/0022666 A1
(43) Pub. Date: Feb. 3, 2005

(54) Method for removal of unreacted alcohol from reaction mixture of ester product with rotating packed beds

(75) Inventors: Wen-Tzong Liu, Hsinchu (TW); Chia-Chang Lin, Hsinchu (TW); Sheng Yang, Hsinchu (TW); Tsung-Jen Ho, Hsinchu (TW); Hua-Tang Yu, Hsinchu (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 10/628,509

(22) Filed: Jul. 29, 2003

(51) Int. Cl. B01D 57/00

(52) U.S. Cl. 95/207; 95/211

(57) ABSTRACT

A method is used to remove an unreacted alcohol from an ester product mixture by a gas stripping. The method involves the feeding of the ester product mixture into proximity of an axis of a rotating packed bed, so as to enable the ester product mixture to flow radially to come in contact with a gas which is introduced into the rotating packed bed. The unreacted alcohol and any other volatile component of low molecular weight are thus stripped from the ester product mixture by the gas entrainment, thereby resulting in production of a purified ester product which is collected at the bottom of the rotating packed bed. The unreacted alcohol and the volatile component, which are entrained in the gas, are discharged via an exit located at the top of the rotating packed bed.

### FIELD OF THE INVENTION

The present invention relates generally to an industrial utilization of a mass transfer equipment, and more particularly to an employment of a rotating packed bed in a process of stripping the unreacted alcohol from the ester product reaction mixture.

### BACKGROUND OF THE INVENTION

The ester product is a reaction product of organic acid and alcohol. The reaction process can be accelerated by using an excess amount of alcohol. The conventional reaction process involves employment of a reactor and a distillation column connected to the reactor for the purpose of separating the distillate water from the alcohol. The reaction is continued by removing the water and by recycling the alcohol. Upon completion of the reaction, the alcohol is removed by distillation. In order to attain a total deprivation of the alcohol remnant, a vacuum distillation is often employed. In general, the removal of the alcohol is effected under lower pressure for a protracted period of time. The quality of the ester product can be adversely affected by a prolonged process of heating in such a manner that the ester product is discolored and degraded. The conventional method of stripping alcohol from an ester product involves the use of an inert gas to carry out a stripping under low pressure until the alcohol content is down to 5000 ppm. If the alcohol content is to be reduced to an extent of 50-500 ppm suitable for the cosmetic product, the method becomes a time-consuming task which may last as long as twelve hours or even longer.

The most commonly-used method of stripping alcohol from an ester product makes use of an aerated agitation tank, by which an aerated dissolution is effected such that an effective gas-liquid contact area is formed. The effective gas-liquid contact area so formed in the liquid phase is relatively small and is regenerated at a slow pace. As a result, the mass transfer between gas and liquid is rather limited. In order to enhance the efficiency of the process, the changes must be made in such a way that the amount of the inert gas is increased, and that the pressure is lowered or that the temperature is raised.

The recent research on application of a rotating packed bed is rather helpful in finding a solution to the problems which can not be easily resolved in the normal gravity field. The mass transfer process is greatly enhanced by the rotating packed bed in such a way that a 2-meter rotating packed bed can be used in place of a 10-meter column, and that the rotating packed bed is exceptionally effective in bringing about an absorption process, a stripping process, or a distillation process, as exemplified by the disclosures of the U.S. Pat. Nos. 4,283,255; 4,382,045; 4,382,900; and 4,400,275. In addition, the Chinese patent publication No. CN1116146A (1996) discloses a process for making ultrafine granule by using the mass transfer equipment in such a manner that a multiphase material flow is fed into the axial position of a rotating packed bed via a distributor from a tubular structure formed of two concentric sleeves. Under the effect of a high gravity field, the material flow comes in contact with the rotating packed bed. Such a technique as described above is relatively new and is still under further investigation. To the best of knowledge of these inventors of the present invention, no prior art dealing with the application of the rotating packed bed to the stripping of alcohol has ever been disclosed.

### SUMMARY OF THE INVENTION

The primary objective of the present invention is to provide a novel method of removing the unreacted alcohol from an ester product mixture. The method involves the use of a relatively less amount of inert gas without raising the temperature of the ester product mixture. The method takes a relatively short period of time to complete.

The present invention makes use of the rotating packed bed to change a gas-liquid contact mode. By means of a relatively high centrifugal force and a relatively high packing effect, the ester product mixture is cut into thinner liquid film and smaller liquid droplet, so as to bring about a high gas-liquid contact area and a high gas-liquid mass transfer efficiency. The process of stripping alcohol from the ester product mixture is therefore enhanced in such a fashion that the stripping duration is shortened, and that the quality of the ester product is improved, and that the alcohol contents of the ester product is effectively reduced.

The method of the present invention is applicable to various ester products, each having a carbon atom number ranging from 10 to 30. The method involves a first step in which an ester product mixture is fed into a rotating packed bed which is revolving on an axis and is sheltered by a housing. The ester product mixture is caused to flow radially so as to flow past a packing which is situated in the rotating packed bed. In the meantime, a gas is introduced into the rotating packed bed such that the gas comes in contact with the ester product mixture which is in the midst of flowing past the packing. As a result, the unreacted alcohol contained in the ester product mixture is stripped by means of the gas entrainment and is then discharged via an exit port on the top of the housing. A purified ester product is collected at the bottom of the housing.

It is preferable that the ester product mixture is guided into the axial area of the rotating packed bed, and that the gas is introduced into the rotating packed bed via the fringe of the housing, thereby enabling the ester product mixture to come in contact with the gas in such a way that the flow direction of the ester product mixture is opposite to the flow direction of the gas at such time when the ester product mixture flows radially to move past the packing.

The gas may be introduced into the rotating packed bed via the axial area of the rotating packed bed, so as to enable the ester product mixture to come in contact with the gas in such a way that both the gas and the ester product mixture flow in the same direction at such time when the ester product mixture flows radially to move past the packing.

The gas may be also introduced into the rotating packed bed from the bottom of the rotating packed bed such that the gas is discharged from the top of the rotating packed bed. As a result, the gas and the ester product mixture come in contact with each other in such a manner that the gas flow and the ester product mixture flow meet at an angle at such time when the ester product mixture flows radially to move past the packing.

It is further suggested that the axial area of the rotating packed bed is exerted on by a negative pressure, so as to allow the ester product mixture to come in contact with the gas in the state of low pressure at such time when the ester product mixture flows radially to move past the packing. The unreacted alcohol is entrained in the gas, which flows past the axial area of the rotating packed bed to escape from the top of the housing.

The purified ester product collected at the bottom of the housing may be recycled as a whole or partially to step a) of the method of the present invention, so that the ester product has a desired purity.

The gas used in the method of the present invention is nitrogen, carbon dioxide, argon, or steam.

The features and the advantages of the method of the present invention will be more readily understood upon a thoughtful deliberation of the following detailed description of three nonrestrictive embodiments with reference to the accompanying drawing.

### BRIEF DESCRIPTION OF THE DRAWINGS

FIG. 1 shows a schematic diagram of a rotating packed bed system suitable for use in the method of the present invention.

### DETAILED DESCRIPTION OF THE PREFERRED EMBODIMENTS

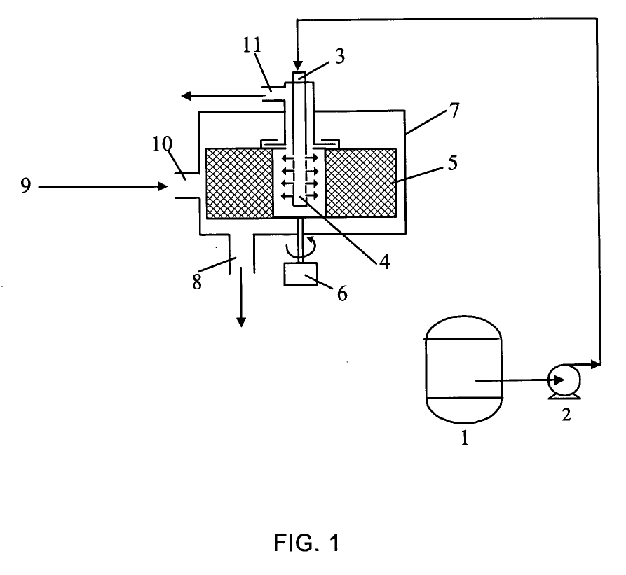

As illustrated in FIG. 1, an ester product mixture is kept in a material tank 1, from which the ester product mixture is pumped by a pump 2 into the axial area of a rotating packed bed via a liquid inlet 3. By means of a liquid distributor 4, the ester product mixture is uniformly sprayed toward an annular packing 5. The liquid is caused to move outward rapidly by an enormous centrifugal force which is generated by a variable motor 6. As a result, the liquid pass the annular packing 5 and gathers at the bottom of a housing 7 prior to being discharged via a liquid outlet 8. In the meantime, an inert gas 9, such as nitrogen, carbon dioxide, argon, or other non-reactive gas, is introduced into the rotating packed bed via a gas inlet 10 such that the inert gas 9 comes in contact with the ester product mixture within the packing 5, with the flow direction of the inert gas 9 being opposite to the flow direction of the ester product mixture. The unreacted alcohol contained in the ester product mixture is thus stripped by means of an entrainment of the inert gas 9. The unreacted alcohol is entrained in the inert gas 9 and is finally discharged via a gas outlet 11.

### EXAMPLE 1

The system shown in FIG. 1 was incorporated into this example in which butyl stearate (BST) was deprived of n-butanol (NBA) by batch. The rotating packed bed had an inner diameter of 78 mm, an outer diameter of 160 mm, and a thickness of 20 mm. The rotating packed bed had a constant rotating speed of 1300 rpm. The packing was a woven net of stainless steel and having a specific surface area of 1906 m²/m³. The packing voidage of the rotating packed bed is 0.91. The packing voidage of the rotating packed bed which is not packing at all is 1, while the packing voidage of the rotating packed bed which is fully packed is zero. This example made use of nitrogen as a stripping agent. In operation, the BST was fed into the rotating packed bed via the liquid inlet 3. The liquid product from the liquid outlet 8 was guided into the material tank 1 and recycled to the liquid input 3. The experimental results are listed in the following Table 1.

TABLE 1

| | Test | |
|---|---|---|
| Conditions and results | 1 | 2 |
| NBA concentration in feed(ppm) | 46205 | 46205 |
| NBA concentration in output (ppm) | 237 (7 min) | 43 (12 min) |
| Liquid feed temperature (° C.) | 120 | 120 |
| Liquid feed rate (g/min) | 250 | 250 |
| Nitrogen feed rate (L/min) | 50 | 50 |
| Rotating speed (rpm) | 1300 | 1300 |

According to the data listed in Table 1, the concentration of NBA contained in the purified product sampled at the liquid outlet 8 at the 7^{th} minute drops to 237 ppm, while the concentration of NBA contained in the purified product sampled at the 12^{th} minute drops further to 43 ppm.

### EXAMPLE 2

The system, as shown in FIG. 1, was used to test the NBA deprivation in a continuous manner. The rotating packed bed had an inner diameter of 20 mm, an outer diameter of 40 mm, a thickness of 20 mm, and a constant rotating speed of 1300 rpm. The packing was a woven net of stainless steel and having a specific surface area of 1546 m²/m³. The packing voidage of the rotating packed bed was 0.90. Steam was used as a stripping agent. The operation was carried out under low pressure by sucking gas at the gas outlet 11. The BST was fed into the rotating packed bed via the liquid inlet 3. The purified product was collected at the liquid outlet 8. The results are listed in the following Table 2.

TABLE 2

Test

| Conditions and results | 1 | 2 |
|---|---|---|
| NBA concentration in feed (ppm) | 46205 | 46205 |
| NBA concentration in output (ppm) | 49 | 43 |
| Liquid feed temperature (° C.) | 111 | 114 |
| Liquid feed rate (g/min) | 132 | 132 |
| Steam feed rate (kg/hr) | 5 | 5 |
| Degree of vacuum (torr) | 160 | 160 |
| Rotating speed (rpm) | 1300 | 1300 |

According to the data listed in the Table 2, it is apparent that the concentration of NBA contained in the purified product ranges from 43 to 49 ppm under the circumstances that the rotating packed bed is continuously operated under low pressure.

### EXAMPLE 3

The system, as shown in FIG. 1, was used to test the deprivation of 2-ethylhexyl alcohol (2-EH) in a continuous fashion. In this example, 2-ethyl hexyl palmitate (EHP) was used in place of BST in Example 2. The results are listed in the following Table 3.

TABLE 3

Test

| Conditions and results | 1 | 2 |
|---|---|---|
| 2-EH concentration in feed (ppm) | 5000 | 5000 |
| 2-EH concentration in output (ppm) | 66 | 104 |
| Liquid feed temperature (° C.) | 205 | 225 |
| Liquid feed rate (g/min) | 54 | 54 |
| Nitrogen feed rate (L/min) | 50 | 50 |
| Degree of vacuum (torr) | 200 | 160 |
| Rotating speed (rpm) | 1500 | 1500 |

According to the data listed in Table 3, the concentration of 2-EH contained in the purified product is less than 100 ppm under the circumstances that the rotating packed bed is continuously operated under low pressure.

1. A method of stripping an unreacted alcohol from an ester product mixture by using a rotating packed bed, the ester product having 10-30 carbon atoms, said method comprising the following steps of:
(a) feeding the ester product mixture into a rotating packed bed which is mounted rotatably on an axis in a housing, so as to enable the ester product mixture to flow radially to move past a packing located in the rotating packed bed; and
(b) introducing a gas into the rotating packed bed such that the gas comes in contact with the ester product mixture at the time when the ester product mixture flows radially to move past the packing, and that an unreacted alcohol contained in the ester product mixture is stripped by means of a gas entrainment and is then discharged via an exit port on the top of the housing, and that a purified ester product is collected at the bottom of the housing.

2. The method as defined in claim 1, wherein the ester product mixture product is fed into the rotating packed bed via an axial area of the rotating packed bed.

3. The method as defined in claim 2, wherein the gas is introduced into the rotating packed bed via the fringe of the housing, thereby enabling the ester product mixture to come in contact with the gas in such a way that the flow direction of the ester product mixture is opposite to the flow direction of the gas at such time when the ester product mixture flows radially to move past the packing.

4. The method as defined in claim 2, wherein the gas is introduced into the rotating packed bed via the axial area of the rotating packed bed, so as to enable the ester product mixture to come in contact with the gas in such a way that the gas and the ester product mixture flow in the same direction at such time when the ester product mixture flows radially to move past the packing.

5. The method as defined in claim 2, wherein the gas is introduced into the rotating packed bed via a bottom of the rotating packed bed such that the gas is discharged from a top of the rotating packed bed, and that the gas and the ester product mixture come in contact with each other at an angle at such time when the ester product mixture flows radially to move past the packing.

6. The method as defined in claim 3, wherein the axial area of the rotating packed bed is exerted on by a negative pressure, so as to enable the ester product mixture to come in contact with the gas under lower pressure at such time when the ester product mixture flows radially to move past the packing, with the unreacted alcohol entrained by the gas being discharged from the top of the housing via the axial area of the rotating packed bed.

7. The method as defined in claim 1 further comprising recycling the purified ester product of the step (b) as a whole or partially to step (a) as a feed, so that an ester product having a desired purity is obtained.

8. The method as defined in claim 1, wherein the ester product is butyl stearate, with the unreacted alcohol being n-butanol.

9. The method as defined in claim 1, wherein the ester product is 2-ethyl hexyl palmitate, with the unreacted alcohol being 2-ethylhexyl alcohol.

10. The method as defined in claim 1, wherein the gas referred to in the step (b) is nitrogen, carbon dioxide, argon, or steam.
